(19) United States
(12) Patent Application Publication
(10) Pub. No.: US 2011/0164087 A1
(43) Pub. Date: Jul. 7, 2011

(54) Apparatus for cleaning inkjet print head

(75) Inventors: Jae Hun Kim, Seoul (KR); Jae Woo Joung, Suwon (KR); Young Seuck Yoo, Seoul (KR); Yoon-Sok Park, Suwon (KR)

(73) Assignee: SAMSUNG ELECTRO-MECHANICS CO., LTD., Suwon (KR)

(21) Appl. No.: 12/805,333

(22) Filed: Jul. 26, 2010

(30) Foreign Application Priority Data
Jan. 7, 2010 (KR) 10-2010-0001278

(51) Int. Cl. B41J 2/165

(52) U.S. Cl. 347/30

(57) ABSTRACT

An apparatus for cleaning an inkjet print head includes: a cleaning plate disposed to correspond to an inkjet print head with an ink flow space interposed therebetween; and a pneumatic device installed in the ink flow space and removing ink in a direction different from a direction in which ink is discharged by changing a fluid pressure of the ink remaining at a nozzle of the inkjet print head.

### CROSS-REFERENCE TO RELATED APPLICATIONS

This application claims the priority of Korean Patent Application No. 10-2010-0001278 filed on Jan. 7, 2010, in the Korean Intellectual Property Office, the disclosure of which is incorporated herein by reference.

### BACKGROUND OF THE INVENTION

1. Field of the Invention

The present invention relates to an apparatus for cleaning an inkjet print head capable of sucking or blowing ink in a direction different from a direction in which an inkjet print head discharges ink.

2. Description of the Related Art

In general, an inkjet print head is a structure for converting an electrical signal into a physical force to make discharge ink in the form of a droplet through a small nozzle. In particular, an inkjet print head assembly includes an inkjet print head having a nozzle plate and a cartridge supplying ink to the inkjet print head.

Recently, a piezoelectric inkjet print head has also been employed in an industrial inkjet printer. For example, ink produced by melting a metal such as gold, silver, and the like, is jetted onto a printed circuit board (PCB) to directly form a circuit pattern, or the piezoelectric inkjet print head is used for industrial graphics, to manufacture a liquid crystal display (LCD) or an organic light emitting diode (OLED), or for a solar cell, and the like.

The nozzle of the industrial inkjet printer must be maintained in an optimum state for printing. To this end, generally, a maintenance operation such as purging, wiping, capping, etc., is performed.

Purging refers to a sort of initialization operation for returning a print head during or after an operation to the state in which it was in before the operation. Wiping refers to wiping out residual ink or debris adhered to the nozzle after purging. Capping refers to separating the nozzle from the exterior.

However, when the ink is removed by contact with the nozzle of the inkjet print head, the nozzle may be clogged or re-contaminated by small fragments of a printing medium or particles generated from wiping.

### SUMMARY OF THE INVENTION

An aspect of the present invention provides an apparatus for cleaning an inkjet print head capable of sucking or blowing ink in a direction different from a direction in which an inkjet print head discharges ink.

According to an aspect of the present invention, there is provided an apparatus for cleaning an inkjet print head, including: a cleaning plate disposed to correspond to an inkjet print head with an ink flow space interposed therebetween; and a pneumatic device installed in the ink flow space and removing ink in a direction different from a direction in which ink is discharged by changing a fluid pressure of the ink remaining at a nozzle of the inkjet print head.

The pneumatic device may be a blowing device for blowing the ink.

The pneumatic device may be a suction device for sucking the ink.

The pneumatic device may be a blowing device disposed at one side of the inkjet print head in a widthwise direction and a suction device disposed at the other side of the inkjet print head in the widthwise direction.

The pneumatic device may be a blowing device disposed at one side of the inkjet print head in the widthwise direction, and a collecting container may be installed at the other side of the inkjet print head in the widthwise direction to collect ink flowing by the blowing device.

The collecting container may include a guide part for guiding a flow of ink into the collecting container.

The pneumatic device may be formed to slope with the nozzle of the inkjet print head.

The pneumatic device may be reciprocally moved in the lengthwise direction of the inkjet print head.

At least one of the inkjet print head and the cleaning plate may be coated with an anti-wetting layer (or a water-repellent layer).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing an inkjet print head assembly and an apparatus for cleaning the inkjet print head assembly according to an exemplary embodiment of the present invention;

FIG. 2 is an exploded perspective view schematically showing an inkjet print head and the cleaning apparatus of FIG. 1;

FIG. 3 is a schematic sectional view taken along line III-III in FIG. 2;

FIG. 4 is a schematic sectional view of an apparatus for cleaning an inkjet print head installed at a line VI-VI in FIG. 2 according to a first exemplary embodiment of the present invention;

FIG. 5 is a schematic sectional view of an apparatus for cleaning an inkjet print head installed at a line VI-VI in FIG. 2 according to a second exemplary embodiment of the present invention; and

FIG. 6 is a schematic sectional view of an apparatus for cleaning an inkjet print head installed at a line VI-VI in FIG. 2 according to a third exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

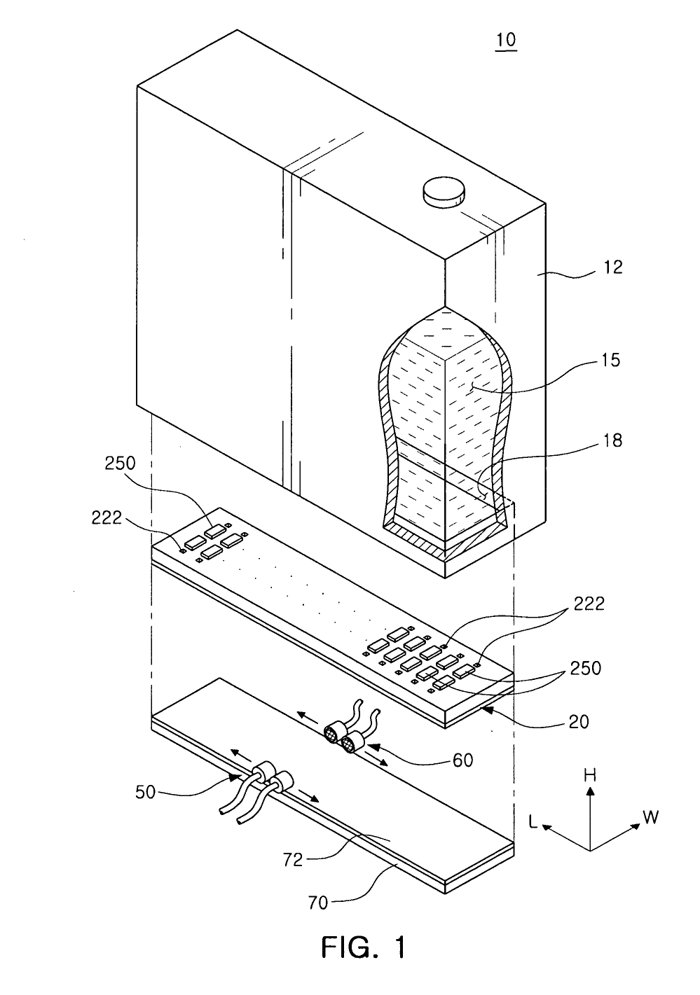

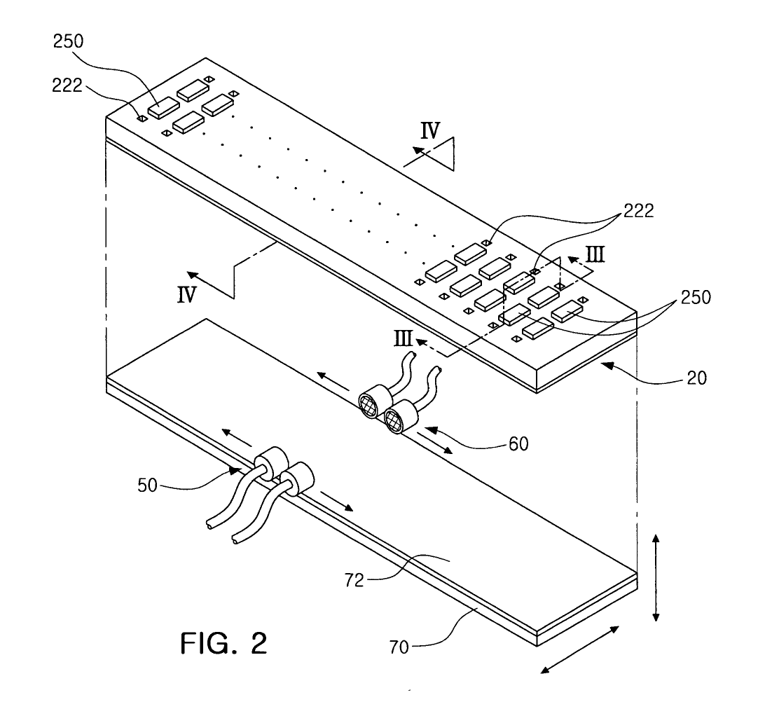

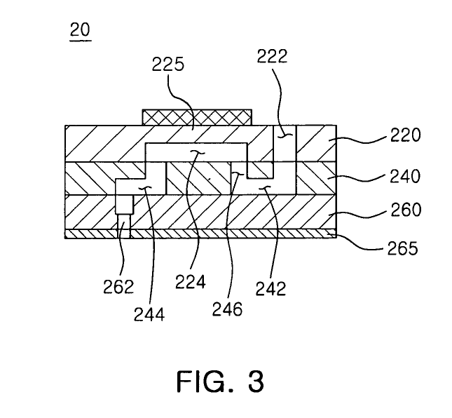

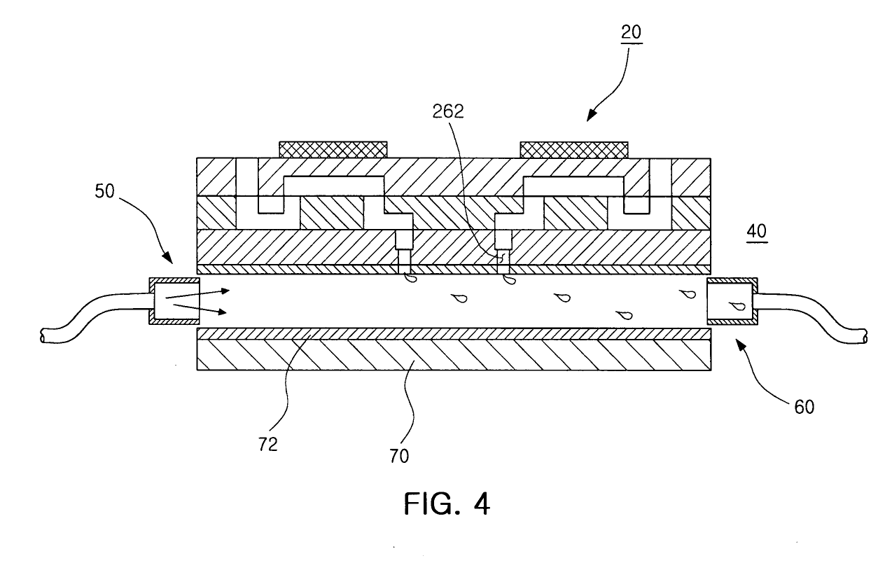

FIG. 1 is an exploded perspective view schematically showing an inkjet print head assembly and an apparatus for cleaning the inkjet print head assembly according to an exemplary embodiment of the present invention, FIG. 2 is an exploded perspective view schematically showing an inkjet print head and the cleaning apparatus of FIG. 1, FIG. 3 is a schematic sectional view taken along line III-III in FIG. 2, and FIG. 4 is a schematic sectional view of an apparatus for cleaning an inkjet print head installed at a line VI-VI in FIG. 2 according to a first exemplary embodiment of the present invention.

With reference to FIGS. 1 to 4, a cleaning apparatus 40 of an inkjet print head assembly according to an exemplary embodiment of the present invention may include a cleaning plate 70 and pneumatic devices 50 and 60.

The inkjet print head assembly 10 employing the cleaning apparatus 40 includes an ink cartridge 12 and an inkjet print head 20.

The ink cartridge 12 is an ink tank storing ink 15 and may include a receiving unit 18 for receiving the inkjet print head 20 having a rectangular parallelepiped shape.

The inkjet print head 20 is a silicon plate stacked body allowing ink to be introduced from the ink cartridge 12 and discharged to an external printing medium.

As shown in FIG. 3, the inkjet print head 20 may be formed by stacking a plurality of boards with recesses and holes formed therein to serve as a flow path.

As for the direction of the inkjet print head 20, the direction H is defined as a heightwise direction of the inkjet print head 20, the direction L is defined as a lengthwise direction of the inkjet print head 20, and the direction W is defined as a widthwise direction of the inkjet print head 20.

The inkjet print head 20 is formed by stacking an upper board 220, an intermediate board 240, and a lower board 260 from an upper side to a lower side in the heightwise direction H.

An ink inlet 222 allowing ink to be introduced into the inkjet print head 20 and a pressure chamber 224 providing a discharge driving force to the ink are formed on the upper board 220. Piezoelectrics 250 may be provided at an upper portion of the pressure chamber 224 with a membrane 225 interposed therebetween in order to provide a driving force for ink discharge.

The piezoelectrics 250 may deform the membrane 225, the upper surface of the pressure chamber 224, to drive discharging of ink. The piezoelectrics 250 are elements capable of converting electrical energy into mechanical energy or vice versa. The piezoelectrics 250 may be typically made of lead zirconium titanate (Pb(Zr, Ti)O₃).

Here, a nozzle 262 is formed on the lower board 260, and a damper 244 and a reservoir 242 storing ink in the head may be formed at the intermediate board 240. Also, a restrict 246 may be formed at the intermediate board 240 in order to prevent ink in the pressure chamber 224 from flowing in reverse into the reservoir 242.

An anti-wetting layer (or a water-repellent layer) 265 is formed on the bottom surface of the lower board 260 to prevent ink residue from remaining on a lower surface of the inkjet print head 20.

The cleaning apparatus 40 for cleaning the inkjet print head 20 of the inkjet print head assembly 10 will now be described.

The cleaning plate 70 is disposed to correspond to the inkjet print head 20 with a certain space, namely, an ink flow space, in which ink may flow according to the blowing or suction of a pneumatic device, present between the cleaning plate 70 and the inkjet print head 20.

The cleaning plate 70 is driven in the heightwise direction H, the lengthwise direction L, and widthwise direction W, at the lower side of the inkjet print head 20 to move to a position corresponding to the inkjet print head 20.

An anti-wetting layer 72 is coated on the cleaning plate 70 to prevent ink from adhering to the cleaning plate 70. As the cleaning plate 70 is disposed at the inkjet print head 20 with the ink flow space present therebetween, the ink flow space may be a channel along which ink moves (or flows).

Meanwhile, the pneumatic device is installed at the ink flow space and removes ink remaining at the nozzle 262 of the inkjet print head 20 in a direction different from a direction in which the ink is charged by changing a fluid pressure.

The ink discharge direction refers to a direction toward a printing medium disposed at a position perpendicular to the nozzle of the inkjet print head 20.

The pneumatic device may be disposed at one side of the inkjet print head 20 in a widthwise direction and driven. Here, the pneumatic device may reciprocally move in the lengthwise direction of the inkjet print head 20.

With reference to FIG. 4, the pneumatic device may be a blowing device 50 for blowing the ink or a suction device 60 for sucking the ink.

In this case, the blowing device 50 may be disposed at one side of the inkjet print head 20 in the widthwise direction, and the suction device 60 may be disposed at the other side of the inkjet print head 20 in the widthwise direction.

When both the blowing device 50 and the suction device 60 are used, a stronger pneumatic pressure can be provided as compared with a case in which only one of them is used.

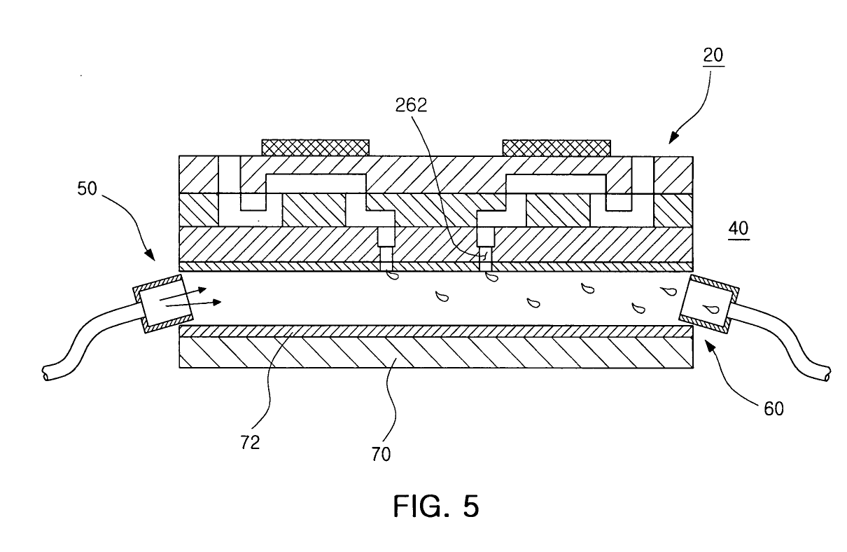

FIG. 5 is a schematic sectional view of an apparatus for cleaning an inkjet print head installed at a line VI-VI in FIG. 2 according to a second exemplary embodiment of the present invention.

With reference to FIG. 5, the blowing device 50 and the suction device 60 may be formed to be sloped with respect to the nozzle 262 of the inkjet print head 20.

Although the blowing device 50 and the suction device 60 are formed to be sloped with respect to the nozzle face of the inkjet print head 20, ink can flow in parallel based on the nozzle face.

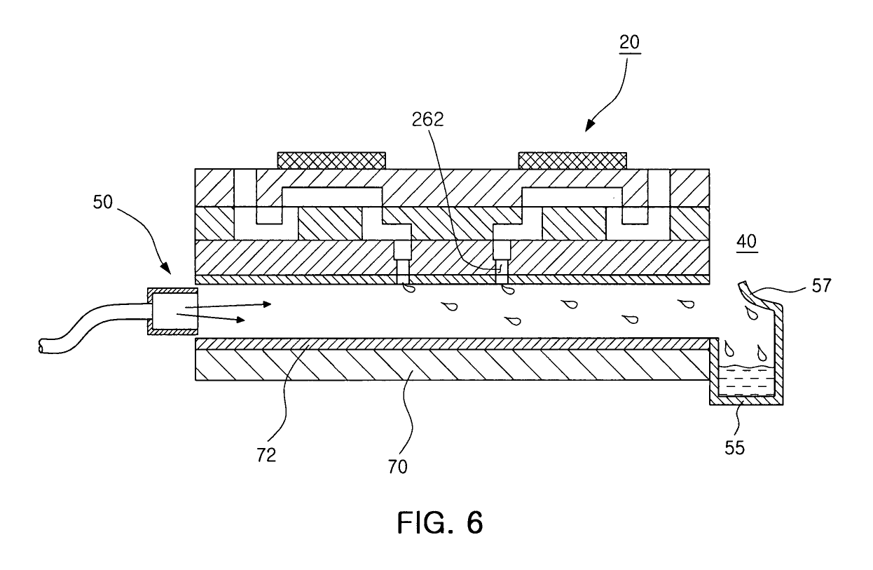

FIG. 6 is a schematic sectional view of an apparatus for cleaning an inkjet print head installed at a line VI-VI in FIG. 2 according to a third exemplary embodiment of the present invention.

With reference to FIG. 6, the blowing device 50 may be disposed at one side of the inkjet print head 20 in the widthwise direction.

In this case, a collecting container 55 for collecting ink flowing by the blowing device 50 may be installed at the other side of the inkjet print head 20.

Here, the collecting container 55 may include a guide part 57 for guiding a flow of ink into the collecting container 55.

As set forth above, in the apparatus for cleaning an inkjet print head according to exemplary embodiments of the invention, because ink is removed without contacting with the nozzle of the inkjet print head, a phenomenon that the nozzle is clogged or re-contaminated by small fragments of a printing medium or particles generated due to wiping can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for cleaning an inkjet print head, the apparatus comprising:
a cleaning plate disposed to correspond to an inkjet print head with an ink flow space interposed therebetween; and
a pneumatic device installed in the ink flow space and removing ink in a direction different from a direction in which ink is discharged by changing a fluid pressure of the ink remaining at a nozzle of the inkjet print head.

2. The apparatus of claim 1, wherein the pneumatic device is a blowing device for blowing the ink.

3. The apparatus of claim 1, wherein the pneumatic device is a suction device for sucking the ink.

4. The apparatus of claim 1, wherein the pneumatic device is a blowing device disposed at one side of the inkjet print head in a widthwise direction and a suction device disposed at the other side of the inkjet print head in the widthwise direction.

5. The apparatus of claim 1, wherein the pneumatic device is a blowing device disposed at one side of the inkjet print head in the widthwise direction, and a collecting container is installed at the other side of the inkjet print head in the widthwise direction to collect ink flowing by the blowing device.

6. The apparatus of claim 5, wherein the collecting container comprises a guide part for guiding a flow of ink into the collecting container.

7. The apparatus of claim 1, wherein the pneumatic device is formed to slope with the nozzle of the inkjet print head.

8. The apparatus of claim 1, wherein the pneumatic device is reciprocally movable in the lengthwise direction of the inkjet print head.

9. The apparatus of claim 1, wherein at least one of the inkjet print head and the cleaning plate is coated with an anti-wetting layer.
